(19) United States
(12) Patent Application Publication
(10) Pub. No.: US 2002/0026474 A1
(43) Pub. Date: Feb. 28, 2002

(54) Thin client for wireless device using java interface

(76) Inventors: Lawrence C. Wang, Cambridge, MA (US); Mark A. Herschberg, Cambridge, MA (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 09/941,003

(22) Filed: Aug. 28, 2001

Related U.S. Application Data
(60) Provisional application No. 60/228,537, filed on Aug. 28, 2000.

(51) Int. Cl. G06F 15/16

(52) U.S. Cl. 709/203; 709/230

(57) ABSTRACT

A thin client resides on a personal data assistant (PDA) and provides functionality for Java applications being executed by a Java virtual machine (JVM) on the PDA. The thin client enhances the PDA's operating system (OS) and facilitates the selection and downloading from a server of Java applications, the exchange of data between applications executing on the PDA, the enablement of the PDA's drivers, peripherals, and software functional components for Java applications, synchronization of data between Java applications on the PDA and the server, security and encryption of data, and maintenance of a connection between the PDA and a server.

### FIELD OF THE INVENTION

The field of this invention relates generally to application programs run on hand-held wireless communication devices, and more specifically to a method and system for distributing and running application programs on hand-held wireless devices.

### BACKGROUND OF THE INVENTION

The growth in use of hand-held computing devices, generically known as Personal Data Assistants, or PDAs, has increased exponentially over the past decade. Although most PDAs currently available have little or no communications capabilities, there is an increasing demand for such capability, and many newer devices offer communications as an included feature or an option. As used herein, the expression “PDA” will refer generally to handheld and other small devices of limited storage means, that have the ability to communicate with other devices such as servers and other such small devices, and that have at least some processing capability. As PDAs have been developed with greater storage and operating memory, they have also been able to run rudimentary applications that have, for the most part, been built into the ROM of the device. Many PDAs are also able to communicate via the Internet, either through factory installed circuitry or through third party add-ons. However, PDAs continue to have a number of significant limitations that restrict their usefulness in many areas of primary interest to potential users. One primary limitation of PDAs and other small communication devices is that they lack the size and flexibility to hold and run many of the specialized applications a given user would consider to be important to his or her needs. If an application is not included in the original configuration, or specifically made available by the manufacturer or authorized third party provider, there is no simple means to provision for loading, running, and configuring additional applications on the PDA.

Although PDAs now commonly include memory of sixteen (16) megabytes or more, such memory is quickly consumed with built-in applications such as operating system, address book, calculator, notepad, spreadsheet, and other commonly included programs. Moreover, the amount of memory available to run an application may be adversely affected by the continuing need to store data developed through other applications.

The problem of limited storage may be alleviated where the PDA is able to communicate with a remote server. Even in this situation, however, there are significant difficulties in making applications available to the PDA user. While it is possible to run the application on the server, with the network connection providing only a viewing or multimedia interface to the PDA, this solution typically suffers from slow responses due to the need for the screen to be repainted whenever the presentation changes. Screen repainting from a server uses a large portion of the available bandwidth just to accomplish that rather menial task and does little to advance the processing of data. In addition, the PDA requires constant communication with the server while the application is running, expending battery power to maintain the connection and limiting the portability of the PDA during processing.

One solution to the problem has been to utilize the Java programming language to create generic applications that are portable across platforms and operating systems. Java is a portable programming language based upon C++that was designed for networked environments, and that achieves its portability in the way that it is compiled and run. Java source code is first compiled to “bytecode.” However, unlike conventional compilers whose output (“object code”) constitutes processor instructions, bytecode consists of instructions to a “Java Virtual Machine” (JVM) that is resident on the platform that will run the application, and that enables the device to run Java programs. The JVM acts as an interface between the bytecode and the operating system, and it is the output of the JVM that constitutes instructions to the operating system. The JVM interprets the bytecode one instruction at a time and translates it into native machine code. The JVM may be supplied by the manufacturer of the PDA, or it may be a third party add-on. In either case, the JVM expands the ability of the PDA to run generic Java programs that are not built into the ROM of the PDA.

While the use of Java and the JVM alleviate some of the traditional limitations associated with developing and running applications on PDAs, there are still a number of areas in which the combination of a JVM and the PDA's operating system are significantly deficient. For example, the combination does not support over-the-air downloading of applications, making application update and distribution on PDAs difficult. Also, JVM typically supports only the “common-denominator” set of features across a variety of devices, which means it is usually limited in its ability to provide a comprehensive interface between Java programs and internal or peripheral devices specific to any particular PDA or the category to which the PDA belongs. Such peripheral devices could include, for example, touch-screen (tablet stlyle) input, hot buttons, wireless modems, infrared (IR) port, and other communications mechanisms needed for communicating with the local or network servers. In addition, the JVM generally is unable to interface satisfactorily with other programs native to the PDA, or with other non-Java software that may have been downloaded for execution on the PDA. Because the JVM is not designed to support extensive communications from the PDA to the server, the JVM has little or no capability for conducting secure dialog with a server, or for synchronizing data on the PDA with data maintained on the server. These, and other deficiencies of the JVM, have hindered the development and delivery of applications onto Java-enabled PDA devices, and have prevented the PDA from performing many of the functions typically associated with larger computers and processors.

Accordingly, there is a need for a “thin client” which extends the functionality of the PDA's resident operating system to Java applications. The thin client provides functionality that is commonly required or beneficial to mobile applications, such as over-the-air application delivery and update, secure communications, over-the-air data synchronization, interfacing with device-specific hardware, and interfacing with non-Java software local to the device. The thin client allows applications running within it to access (share) the functionality it provides.

### SUMMARY OF THE INVENTION

The system of this invention utilizes a “thin” Java-based client to reside upon a PDA and to enhance the PDA's native operating system (OS) and a Java Virtual Machine (JVM) by providing functionality catered for mobile applications written in Java. The thin client serves as an interface between a Java application and the JVM.

In addition to its own operating system and the JVM, the PDA will normally have some native applications that are always available to it. However, the full power and flexibility of the PDA will be utilized only when Java applications can be downloaded over-the-air and run on the PDA together with the PDA's native applications, and data and information can be exchanged among applications. Application programs are maintained on a server in Java bytecode, and may be downloaded to the PDA when the user desires to run them. The thin client, which has a software counterpart on the server for file transfer and synchronization, establishes a connection to the server that may be long-term or temporary, depending upon the particular application, user preference, and external factors that may affect connectivity. When connected, the thin client presents a selection interface through which a desired program can be selected and downloaded by the user. While the program is running, the thin client provides an interface to other native and third party PDA applications and connectivity to any needed internal or peripheral devices or ports. When an application has finished running, it may be released from memory, only to be recalled and downloaded again when needed in the indefinite future, or it may be retained on the PDA until specifically erased from memory.

The thin client incorporates a memory manager to manage the PDA's memory, and that can create one or more caches to hold and maintain code and data during periods of offline use. Because downloaded applications do not need to permanently reside on the remote device, substantially all of the device's free memory can be made available to whatever application is running at any given time, if necessary.

In the method of this invention, one or more applications, in the form of Java bytecode written and compiled based on the thin client Application Program Interface (API) are downloaded from a server to a PDA where they are run with the thin client. Instructions from the downloaded applications and the thin client are translated by the JVM into processor instructions. In order to support the PDA-specific features on the different operating systems, native applications, and hardware, used by different PDA's, the thin client is often unique for each PDA model, and resides on the PDA. However, because the thin clients of different PDA's expose the same set of API's to the Java applications written against it, a single server can provide the same Java application to a variety of PDAs using different operating systems.

The system requires application programs to be written in Java, which is a high portability programming language. The high portability of that language makes it ideal for use with a variety of remote wireless devices. Because a Java interface is used, any Java program may be stored on the server and downloaded to the PDA. However, it is apparent that the greatest performance is only achieved when programs are well-written to meet the goals of compactness and efficiency, and are specifically designed to take advantage of the facilities that are made available through the thin client interface. These goals are complimentary to the Java programming language, as its portability makes it worthwhile for programmers to write but a single, compact and efficient program that may be used on a variety of devices made by different manufacturers.

Accordingly, it is an object of this invention to alleviate the problem of limited storage that is inherent in small devices. It is a further object of this invention to provide a thin client that will interface with a PDA's JVM and with standard Java applications and other applications native to the PDA. It is another object of the invention to make a large library of applications and peripheral interfaces available for use in small, remote devices through wireless downloads of only those applications that may be needed at any given time. Yet a further object of the invention is to promote the development of code that is compact and efficient, and that can take advantage of facilities provided by the thin client, thereby freeing up limited memory for use in running the application and enabling downloads to be made rapidly over limited-bandwidth channels. Another object of the invention is to allow applications to reside and run on the device, so as to allow the user to run them with or without an active connection to the server. These and other objects of the invention will be seen through the following sections of this disclosure.

### BRIEF DESCRIPTION OF THE DRAWINGS

FIG. 1 is a flow chart depicting communications between a PDA and a distribution server when selecting and downloading an application program.

FIG. 2 illustrates the PDA display screen prior to the download of external applications.

FIG. 3 illustrates the PDA selection screen showing a menu of programs available for download.

FIG. 4 shows the PDA screen after one or more applications have been downloaded and are ready to be run.

FIG. 5 graphically depicts the thin client residing between any downloaded Java application and the JVM and the operating system of the PDA.

FIG. 6 illustrates a conceptual configuration for the thin client of this invention, demonstrating control relationships between the application, JVM, the PDA's operating system, the thin client, and various other devices and programs.

### DETAILED DESCRIPTION OF THE PREFERRED EMBODIMENTS

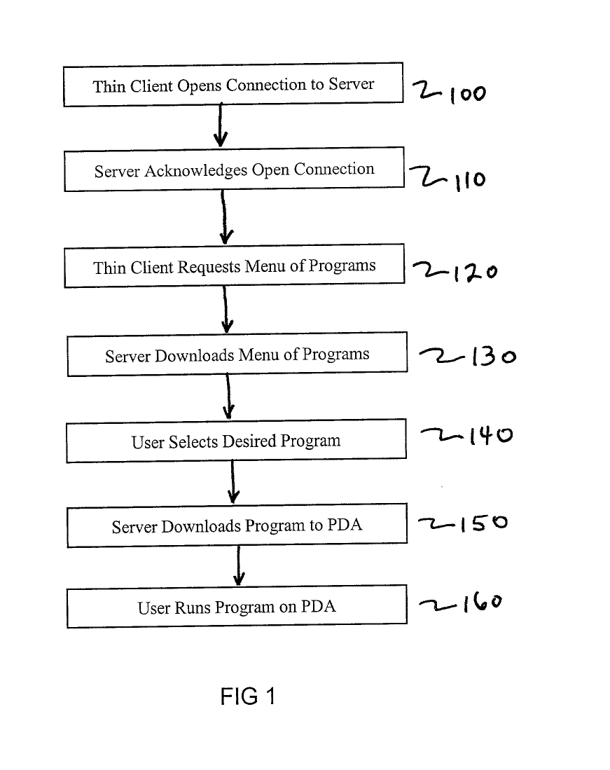

In FIG. 1, the sequence begins when the PDA has been turned on and the user wishes to download an application that is maintained on a distribution server. The first step 100 is for the thin client residing on the PDA to open a connection to the distribution server and to obtain acknowledgment from the server 110. Although this system may be used in any client-server environment, it is uniquely suited for narrow bandwidth, wireless communications in which a remote client is connected to a distribution server only long enough for the user to select and download the desired application. Constant communication between client and server is not required since the PDA will perform all necessary processing locally and internally, once the application has been downloaded and resides on the device. Potential environments for this wireless connection include but are not limited to wireless technologies such as CDPD (Cellular Digital Packet Data), GSM (Global System for Mobile Communications), GPRS (General Packet Radio Service), CDMA (Code Division Multiple Access), and CDMA2000. Another potential environment for this wireless connection is the short range wireless technology known as “Bluetooth.” Devices using this technology can communicate at distances from 10 to 100 meters without a wire connection, so long as both are Bluetooth enabled. Because of Bluetooth's short range and coverage limitation, the thin client model is particularly complementary because a constant connection is not required when running applications.

Once the PDA—distribution server connection is open, the thin client requests a menu of available application selections from the distribution server 120. The server responds with a menu of applications, which preferably but not necessarily will be Java applications that are available to be downloaded 130. In some configurations, the thin client may have retained a recent version of the menu in its storage. In that case, the server will have information from which it may determine the PDA's most recently loaded menu, and will simply download information sufficient to update the PDA's menu without downloading the entire menu. This process would result in a smaller, hence faster, download and, where the applications menu has not been modified since the last menu call, could avoid a menu download altogether. The menu is then displayed and the user's selection is made and sent to the server 140. The server then downloads to the PDA the selected application 150 which may constitute a Java program that interfaces with the Java “thin” client. It is possible, but not required, that other relevant information such as user-specific configuration files, program data, or anticipated program overlays, may also be downloaded at this time. Following a download of the program, the bytecode will then sent to the JVM to run the application 160.

As previously noted, applications suitable for use in this invention should be specifically designed as compact, efficient programs that take advantage of facilities available through the thin client. Programs of 30K to 40K bytes can provide adequate functionality and features without overwhelming the PDA's memory. However, as additional PDA memory becomes available at reasonable costs, larger programs providing additional features could be used in the PDA environment. When a connection is opened for menu or application download, the thin client may also receive information from the server regarding any updates to the current version of the thin client or to any applications programs that may be available. New versions can be downloaded at this time, and such downloads may be necessitated where an application requires a particular version of the thin client.

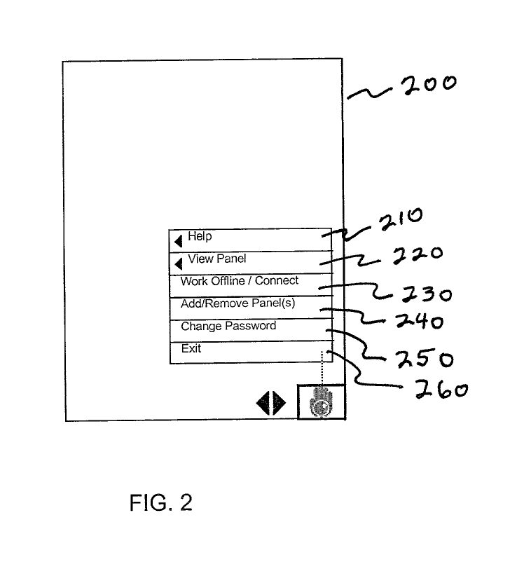

FIG. 2 shows an example of a display 200 provided by the thin client before any applications have been downloaded. Selections include a help screen 210, a view panel 220 from which applications may be run, a “work offline/connect” selection 230 for the user to choose operating mode, an add or remove panel selection 240 for adding or deleting locally available applications, a change password option 250, and a choice to exit 260. Display 200 can be the initial start-up screen for the PDA, or it may be the first screen to appear after the user has chosen to run a non-resident application.

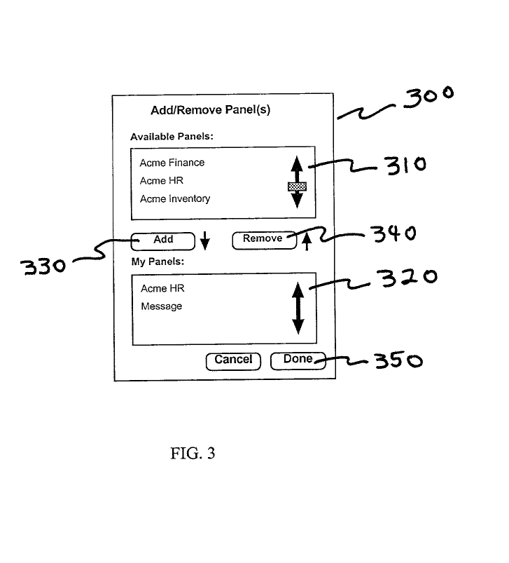

If the user chooses to add or remove panels, the next screen will be as shown in FIG. 3. The “Add/Remove Panel(s)” display 300 includes an upper window 310 showing applications available for download, and a lower window 320 showing panels that have already been selected. “Add” and “Remove” buttons 330 and 340 are used to modify selections. When applications to be downloaded have been selected, the download process is initiated by using the “Done” button 350. While available programs will normally be Java applications, it is also possible to include customization and data files to accompany an application. Such files could be accessed by the Java application running on the PDA.

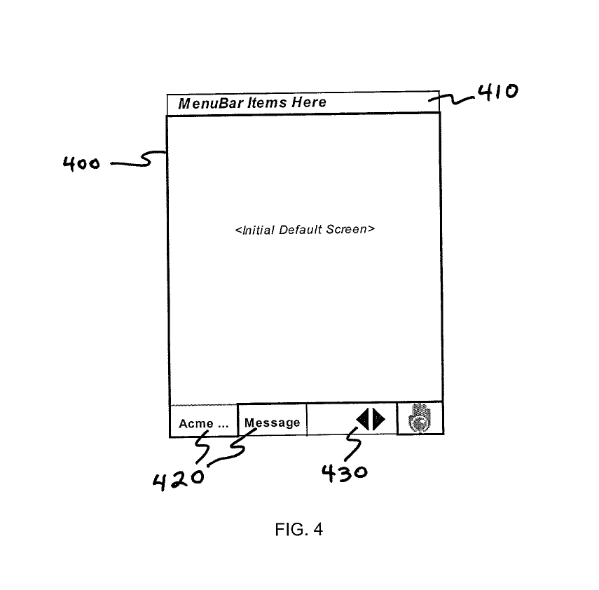

FIG. 4 shows one embodiment of how applications will be displayed for selection on the PDA. Display window 400 has a menu bar 410 showing menu selections appropriate to the operating system and the selection of an application. Tabs 420 at the bottom of display window 400 provide applications by name. Right and left arrows 430 permit scrolling of the display so that other downloaded or resident applications may be accessed.

The thin client is specific to each PDA model and provides an interface to the JVM that utilizes the PDA's operating system. However, it appears as a generic interface to the Java applications to be downloaded, and permits the Java applications to be entirely portable to any PDA running the corresponding version of the thin client. This ensures that a single server will be able to deliver virtually any standard Java application to any PDA using this invention.

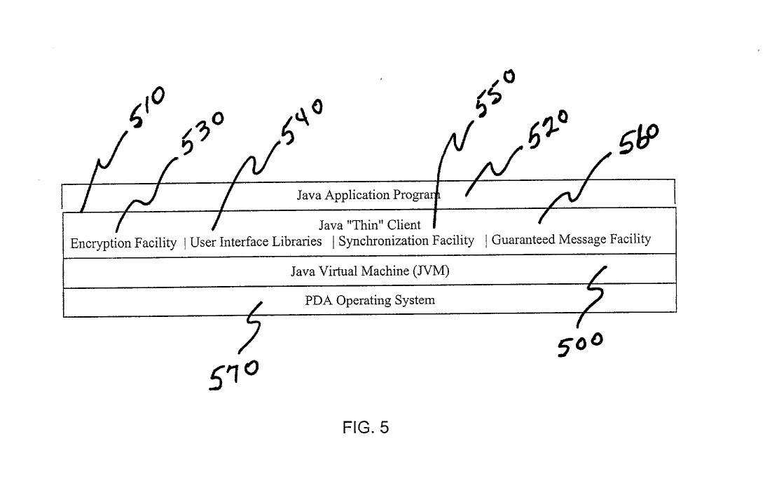

In FIG. 5, it may be seen that the thin client 510 resides between the JVM 500 and the downloaded Java application program, 520, and consists of a set of services that may be invoked by the downloaded applications. Such services may include an encryption facility 530, user interface libraries 540, a synchronization function 550 that can be invoked by an application to write data from client to server, a guaranteed message delivery facility 560, and a driver interface for PDA-specific devices. Because the thin client makes these extended services available to all downloaded programs, it is not necessary that the same facilities be included in each download. By including these services in the thin client, the size of all downloads to the PDA may be reduced, with a corresponding reduction in time required for the downloads and in the amount of storage needed to maintain the programs on the server, without sacrificing functionality or features of the downloaded programs. The JVM 500 provides a virtual Java machine to the thin client 510, and interacts directly with the PDA operating system 570. In order to keep client-server transmissions to a minimum, communications between server and PDA will normally take place under UDP, in which message confirmation has been built into the client-server software. If confirmation of a transmission cannot be obtained, then the user is notified of that fact. Communications may also be encrypted for security, and an auto-delete feature may be used to delete sensitive information after the PDA has been idle or turned off for a predetermined length of time. The thin client may also include a synchronization facility whereby information maintained on the server may be updated, or synchronized, with data created or modified by an application running on the PDA. Synchronization used in conjunction with the secure message facility ensures that synchronization has taken place, or alerts the user to the possibility that it has not yet been done.

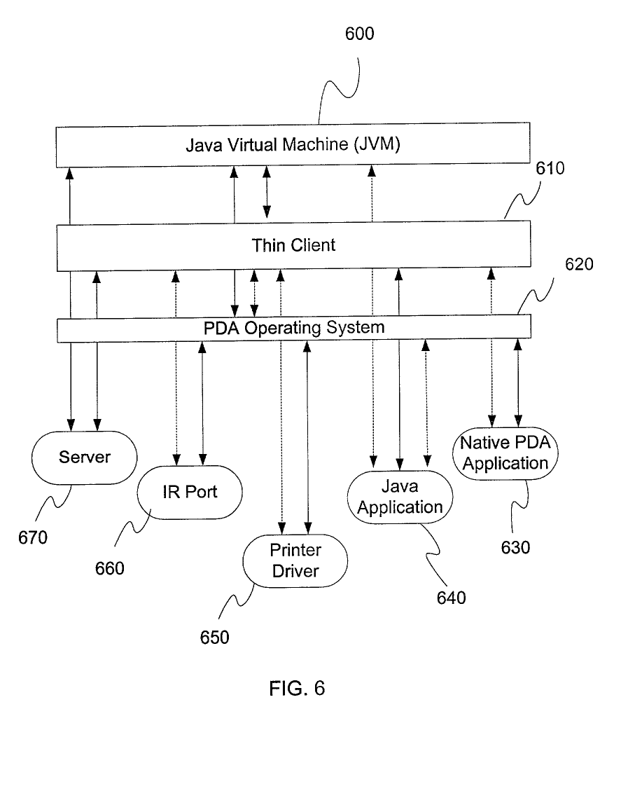

FIG. 6 illustrates a conceptual exemplary embodiment of the invention in which the relationships between the thin client, the JVM, the PDA's operating system, and other functions are graphically depicted. It must be noted that FIG. 6 is intended to demonstrate conceptual control of the facilities shown, rather than actual, physical interconnections between them. As depicted, the PDA's OS 620 executes a native PDA application 630, and has direct control of an IR port 660, and a printer driver 650. Other facilities such as, for example, an external keyboard or monitor, are not shown, but would be similarly controlled by the OS and the thin client. Direct control is indicated by solid double-headed arrows pointing to the referenced objects, while background control or interfaces are indicated by broken double-headed arrows. The OS also controls a running Java application 640. In this case, the code for the Java application was originally download from the server 670 in accordance with instructions provided by the thin client 610, and is run within the thin client. Although a single Java application is depicted 640, the invention is not so limited, and a user can select, download, and execute more than one Java application at a time. Instructions from the Java application 640 and the thin client 610 are interpreted by the JVM 600, which then passes machine code to the OS 620 to run the Java application leveraging functions provided by the thin client.

The thin client of this invention 610 provides interfaces between the Java application 640 and some or all of the facilities shown in FIG. 6. In FIG. 6, it may be seen that the thin client 610 directly controls some communications with the server 670. This control is exercised in the dialog necessary to obtain and present a list of programs available for downloading, and in the implementation of the default connection mode between the PDA and the server. Depending upon user preferences, the type of applications being utilized, and the external environment, the thin client can establish a long-term real-time connection between the PDA and the server, or alternatively can set up a short-term connection for the purpose of downloading only such applications as will be needed to work offline. In the long-term, real-time mode, the thin client will attempt to maintain a constant connection with the server and if the connection is inadvertently lost, will automatically attempt to regain it. At the same time, when the connection is lost, the thin client will cache application data and parameters, and will permit the user to continue using the application offline, if possible, while restoration of the connection is attempted. Data synchronization will also be carried out through the thin client's direct control over the connection with the server 670, through which data on the server can be synchronized to conform to data on the PDA, or conversely, data on the PDA can be synchronized to conform to data on the server, depending upon the particular application and user choices. As previously noted, the server will be running complementary software such that, upon the initiation of a synchronization sequence by the thin client, data on the server and the PDA may be synchronized.

As shown in FIG. 6, the thin client also provides an interface between the Java application 640 and peripherals requiring specific drivers such as the IR port 660 or the printer 650. The thin client also provides an interface between the Java application and native PDA applications. Additional functions such as data encryption, user interface libraries, and other facilities, will be similarly controlled by the thin client operating in conjunction with the PDA's OS and the JVM.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. In a PDA having a processor, an operating system, a memory and a communication link with a server, a method for retrieving and executing Java applications comprising the steps of:
initiating a connection from a PDA to a server;
displaying a menu of available programs to a user;
upon the user's selection of one or more programs, retrieving said selected one or more programs from said server and copying said selected one or more programs into said memory,
executing said selected one or more programs on said PDA,
providing one or more links whereby said selected one or more programs may use facilities on said PDA,
providing one or more links whereby said selected one or more programs may exchange information with other programs executing on said PDA,

2. A method for retrieving and executing Java applications as claimed in claim 1 wherein said selected one or more programs are Java applications that consist of bytecode instructions, and said PDA also includes a Java virtual machine that processes said bytecode instructions and sends machine instructions to said PDA's operating system.

3. A method for retrieving and executing Java applications as claimed in claim 2 wherein said available programs displayed on said menu are Java applications.

4. A method for retrieving and executing Java applications as claimed in claim 3 wherein said connection to said server is a wireless connection that is maintained during execution of said selected one or more programs.

5. A method for retrieving and executing Java applications as claimed in claim 4 wherein, if said wireless connection to said server should be broken while said selected one or more programs are executing, said wireless connection will automatically be reestablished.

6. A method for retrieving and executing Java applications as claimed in claim 3 wherein said connection to said server is a wireless short-term connection that is terminated after said selected one or more programs has been copied to said memory of said PDA.

7. A method for retrieving and executing Java applications as claimed in claim 3 further comprising the step of terminating the execution of said selected one or more programs upon a user's entry of a termination signal.

8. A method for retrieving and executing Java applications as claimed in claim 7 wherein said step of retrieving and copying said selected one or more programs to said memory further comprises maintaining said selected one or more programs in said memory following said termination of said selected one or more programs until said selected one or more programs are released from said memory upon the occurrence of a user initiated action.

9. A method for retrieving and executing Java applications as claimed in claim 3 wherein information generated by said selected one or more programs is transmitted to said server for synchronization of information preexisting on said server.

10. A method for retrieving and executing Java applications as claimed in claim 3 wherein information on said server is transmitted to said PDA for synchronization of information preexisting on said PDA.

11. A method for retrieving and executing Java applications as claimed in claim 3 wherein, said step of displaying a menu of available programs to a user further comprises the receipt by said PDA of menu information from said server.

12. A method for retrieving and executing Java applications as claimed in claim 3 wherein said step of retrieving menu information from said server further comprises retrieving only sufficient information such that, when said retrieved information is merged with other information preexisting in said PDA's memory, said menu of available programs will be displayed as a complete menu.

13. A method for retrieving and executing Java applications as claimed in claim 3 wherein said step of providing one or more links to facilities on said PDA further comprises providing links to one or more facilities taken from the group consisting of an IR port, a parallel port, a serial communications port, a wireless communications port, a network interface, a port for a camera, a port for connecting to a sound system, a port for connecting to a cellular telephone, a port for connecting to a television, a SCSI interface, a disk drive, a modem, an external keyboard, a mouse, a graphical input tablet, and an external monitor.

14. A method for retrieving and executing Java applications as claimed in claim 3 wherein said step of providing one or more links for exchanging information with other programs operating on said PDA further comprises converting said information into a format from which it may be received and processed by each said program to which said information will be provided.

15. A method for retrieving and executing Java applications as claimed in claim 14 wherein said other programs operating on said PDA are programs that permanently reside with in said PDA.

16. A method for retrieving and executing Java applications as claimed in claim 3 wherein said wireless connection is a narrow bandwidth connection.

17. A method of retrieving and executing Java applications as claimed in claim 3 wherein said connection to said server comprises encrypted communications.

18. A method of retrieving and executing Java applications as claimed in claim 3 wherein said connection to said server is a wireless connection and, if said wireless connection should be broken while data is being transmitted across said connection, data transmission will automatically be resumed upon reconnection.

19. In the memory of a PDA having a processor, an operating system, a display, a plurality of services, and a communications link to a server, said memory containing a Java virtual machine (JVM), a thin client for providing services to a one or more selected Java applications comprising:
a module for initiating and maintaining a connection from a PDA to a server;
a module for displaying a menu of available programs on said server to a user;
a module for retrieving one or more selected Java application s from said server and copying said one or more selected Java application into said memory,
a module for interfacing with said JVM and said operating system to execute said one or more selected Java applications on said PDA,
a module for linking said one or more selected Java applications to facilities on said PDA needed to run said one or more selected Java applications,
a module for exchanging information between said one or more selected Java applications and other programs executing on said PDA,
said modules being interconnected whereby said thin client provides an interface between said one or more selected Java applications and at least one or more of said server, said JVM, said operating system, said other programs, and said facilities on said PDA to enable said one or more selected Java applications to utilize said services.

20. A thin client as claimed in claim 19 further comprising a module for terminating the execution of said one or more selected Java applications upon the receipt of a termination signal.

21. A thin client as claimed in claim 20 wherein said module for displaying a menu of available programs for downloading from said server further comprises a module for retrieving at least a portion of a menu of available programs from said server and displaying said menu on said display.

22. A thin client as claimed in claim 19 wherein said connection comprises a wireless connection.

23. A thin client as claimed in claim 19 wherein said connection comprises an encrypted communications link.

24. A processor in a PDA wherein said processor is programmed to initiate and maintain a connection from said PDA to a server;
to retrieve from said server at least a portion of a menu containing programs available for downloading from said server;
to retrieve from said server and execute on said PDA one or more selected Java applications;
to provide one or more facilities to said one or more selected Java applications from the group consisting of a wireless connection to said server, an IR port, a parallel port, a serial communications port, a network interface, a port for a camera, a port for connecting to a sound system, a port for connecting to a cellular telephone, a port for connecting to a television, a SCSI interface, a disk drive, a modem, an external keyboard, a mouse, a graphical input tablet, and an external monitor;
to exchange data between said one or more selected Java applications and other programs on said PDA.

25. A processor in a PDA as claimed in claim 24 wherein said processor is additionally programmed to initiate one or more connections to one or more remote processing devices and to send to said one or more remote processing devices data developed by said one or more selected Java applications.

26. A processor in a PDA as claimed in claim 24 wherein said connection is a wireless connection.

27. A processor in a PDA as claimed in claim 26 wherein said processor is additionally programmed to maintain said wireless connection to said server until execution of said one or more selected Java applications has terminated.

28. A processor in a PDA as claimed in claim 26 wherein said processor is additionally programmed to terminate said wireless connection to said server before or during execution of said one or more selected Java applications such that said wireless connection is closed during at least a portion of the time said one or more selected Java applications are executing.

29. A processor in a PDA as claimed in claim 26 wherein, if said wireless connection should be terminated during the transfer of data across said connection, said processor is additionally programmed to automatically reestablish said connection and resume said transfer of data.
